(19) United States
(12) Patent Application Publication
(10) Pub. No.: US 2004/0221750 A1
(43) Pub. Date: Nov. 11, 2004

(54) Embossing guide

(76) Inventor: Robert Arnold, Spokane, WA (US)

Correspondence Address: SOFER & HAROUN, L.L.P., Suite 910, 317 Madison Avenue, New York, NY, 10173, US

(21) Appl. No.: 10/429,911

(22) Filed: May 5, 2003

(51) Int. Cl. B31F 1/07

(52) U.S. Cl. 101/3.1

(57) ABSTRACT

The present invention describes an embossing guide for embossing a design into a sheet media. The embossing guide has first and second guidelines on the top of the embossing guide meeting at a defined angle. An embossing cutout is also provided, disposed within the defined angle formed by the first and second guidelines such that when a corner and sides of the sheet media are aligned against the first and second guidelines, the sheet media will be accurately placed over the embossing cutout such that a stylus moved around the edges of the embossing cutout will emboss a desired design into the sheet media at the specified location.

### FIELD OF THE INVENTION

This invention relates to an embossing guide. More specifically, this invention relates to an embossing guide for use with mounting photos.

### BACKGROUND OF THE INVENTION

This invention relates to the use of a guide tool to emboss sheet media such as craft paper and the like. In the art of scrapbooking or other arts and crafts it is sometimes desirable to mount pictures or other items directly onto the sheet media being used. In this case there are a variety of means that can be used to mount the picture onto the media.

Mounting methods such as glue or corner tacks may be used but the glue often comes undone from the sheet media over time allowing the picture to fall from its desired location.

A more sound method of attachment involves the use of a punch tool so as to cut the sheet media allowing the corners of the picture to be mounted to be pressed into the slots created. The punch tools used may include manually operated punch tools such as those commonly referred to as “craft punches,” corner punches” or “corner rounders” to produce decorative or function holes or edge shapes in the comers of sheet media such as paper or card stock. These punches typically comprise a metal die with a spring loaded metal punch and housing, typically fabricated with plastic, and may include internal guides for the comers of the media being punched.

However, the use of such punch tools alone does not provide the mounting of the picture into the scrap book with desirable looking edges. For example, the use corner tacks provides a more aesthetically pleasing look, than the simple use of slits through which the edges of a corner are placed. However, as discussed above, these corner tacks which are glued to the sheet media often fall off of the paper.

As such, it desirable to provide a more stable means for mounting photos onto a sheet media while at the same time, providing a more decorative and aesthetically appealing mounting.

### SUMMARY OF THE INVENTION

The present invention looks to overcome the drawbacks associated with the prior art and provides for an embossing guide.

To this end, the present invention provides for a an embossing guide for embossing a design into a sheet media. The embossing guide has first and second guidelines on the top of the embossing guide meeting at a defined angle. An embossing cutout is also provided, disposed within the defined angle formed by the first and second guidelines such that when a corner and sides of the sheet media are aligned against the first and second guidelines, the sheet media will be accurately placed over the embossing cutout such that a stylus moved around the edges of the embossing cutout will emboss a desired design into the sheet media at the specified location.

### BRIEF DESCRIPTION OF THE DRAWINGS

FIG. 1a is a top view of the embossing guide, in accordance with one embodiment of the present invention;

FIG. 1b is a bottom view of the embossing guide as illustrated in FIG. 1a, in accordance with one embodiment of the present invention;

FIG. 2 is a top view of the embossing guide of FIG. 1a having a sheet media disposed thereon, in accordance with one embodiment of the present invention;

FIG. 3 is a top view of the embossing guide from FIG. 1a, having a sheet media disposed thereon and an embossing stylus, in accordance with one embodiment of the present invention;

FIG. 4 is a top view of the sheet media having a picture disposed thereon, in accordance with one embodiment of the present invention; and

FIG. 5 is a flow chart illustrating the steps of operation for the embossing guide as illustrated, in accordance with one embodiment of the present invention.

### DETAILED DESCRIPTION

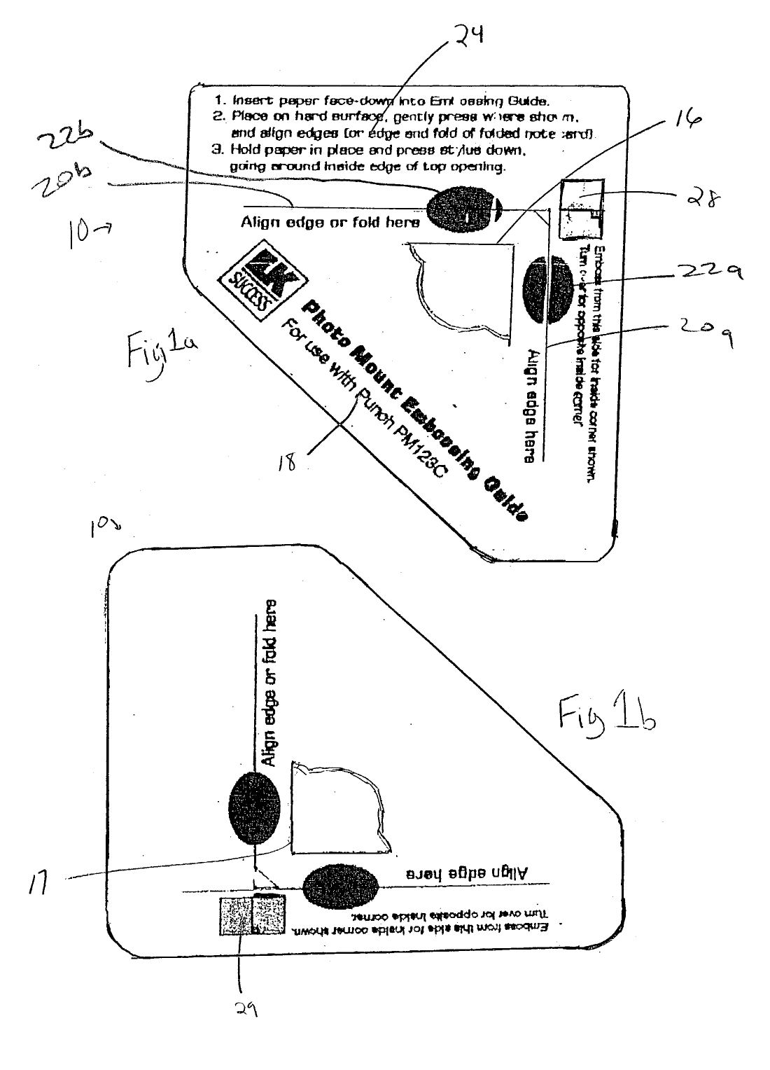

In one embodiment of the present invention and with reference to FIGS. 1a and 1b, an embossing guide 10 is configured to provide a means for accurately embossing a sheet media 14 in conjunction with the mounting of a photo thereon.

To this end, as illustrated in FIGS. 1a and 1b, embossing guide 10 is preferably constructed of sturdy material such as hard polymer. However, it should be noted that the materials described herein for the construction embossing guide 10 are intended only as examples of possible materials to be used however, any such durable sturdy material that can be used as a base for embossing sheet media 14 are within the contemplation of the present invention.

Embossing guide 10 maintains an embossing cutout out 16 which corresponds to the shape to be embossed in sheet media 14. Embossing cutout 16 is preferably in the shape of traditional photo mounts, however, any ornate or decorative shape for embossing guide 16 is within the contemplation of the present invention.

The shape of embossed region on sheet media 14 needs to correspond to a slit 40 cut into sheet media 14 by a punch tool. As such, embossing cutout 16 is only limited in shape by the number of shapes carried by the corresponding line of punch tools. Embossing guide 10 maintains a corresponding punch indicia 18, illustrated in FIG. 1a, that indicates which punch tool is to be used with the particular embossing guide 10. Although corresponding punch indicia 18 is located on the top of embossing guide 10, this is intended only as an exemplary location and is in no way intended to limited to the scope of the present invention. Corresponding punch indicia 18 may be located anywhere in embossing guide 10.

In one embodiment of the present invention as illustrated in FIG. 1a, embossing guide 10 maintains an instruction indicia 24 on its upper side, that indicates to the user the manner of operation. Although instruction indicia 24 is located on the top of embossing guide 10 this is intended only as an exemplary location and is in no way intended to limited to the scope of the present invention. Instruction indicia 24 may be located anywhere in embossing guide 10.

The underside of embossing guide 10, as illustrated in FIG. 1b, maintains similar features to the upper side. In particular, a corresponding complimentary embossing cutout 17 is provided, on the underside of embossing guide 10 as illustrated in FIG. 1b, configured to be used to perform the embossing on opposing sides of sheet media 14.

For example, typical in scrap booking, a particular page of sheet media 14 may be folded. In such a case it may be necessary to place embossed areas near the middle of the folded sheet media 14. As such, when performing an embossing along the middle axis of a folded sheet media 14, a first embossing is performed using embossing cutout 16 on the top side of embossing guide 10, illustrated in FIG. 1a. Subsequently, a second embossing is performed using the corresponding mirror image complimentary embossing cutout 17 located on the under side of embossing guide 10, illustrated in FIG. 1b.

As illustrated in FIG. 1a, a center axis embossing guide alignment indicator 28 is disposed on the upper side of embossing guide 10 to instruct the user on the proper side of embossing guide 10 to be used for a particular location to be embossed on sheet media 14. A second center axis embossing guide alignment indicator 29 is also located on the under side of embossing guide 10 for the same purposes.

The operational features of both the upper and lower side of embossing guide 10 are similar and as such the remainder of features of embossing guide 10 will be described with reference to the upper side of embossing guide 10, illustrated in FIG. 1a.

In one embodiment of the present invention as illustrated in FIG. 1a, first and second alignment guidelines 20a and 20b are disposed on the surface of embossing guide 10, such that a right angle is formed for aligning the corner of sheet media 14. It is noted that first and second guidelines 20a and 20b, formed in a right angle, are intended only as one possible example, however, any angle of incidence formed by first and second guidelines 20a and 20b for use with alternately shaped sheet media 14 is also within the contemplation of the present invention.

First and second guidelines 20a and 20b are arranged such that, when the edges and corner of sheet media 14 are aligned with them, the corner of sheet media 14 will be disposed over embossing cutout 16 in such a way that the resulting embossing, will correspond to the cut made in sheet media by the punch tool identified in punch indicia 18. A more detailed description of the operation of the punch in conjunction with the embossed area formed by embossing cutout 16 is discussed in more detail below.

Finger locations 22a and 22b, are positioned along first and second guidelines 20a and 20b respectively, so that a user may hold sheet media 14 in proper alignment during the embossing procedure discussed below.

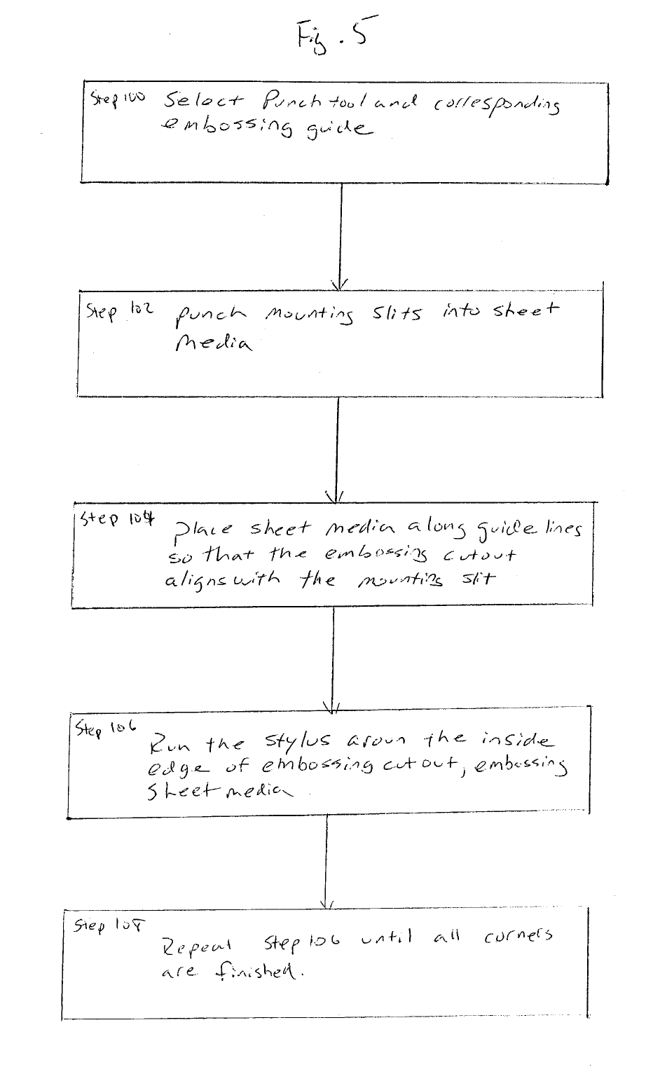

In one embodiment of the present invention, as illustrated in flow chart FIG. 5, in operation, a sheet media 14 is selected by a user to have a item mounted thereon such as a photo 15. Subsequently, as step 100, an embossing guide 10 is selected based on the desired design of embossing cutout 16. For the purposes of illustration, embossing guide 10, illustrated in FIG. 1a, having a photo corner mount design for embossing cutout 16, is used to illustrate the operation of the present invention. After selecting an embossing guide 10 the corresponding punch tool is obtained based on the information contained in punch indicia 18.

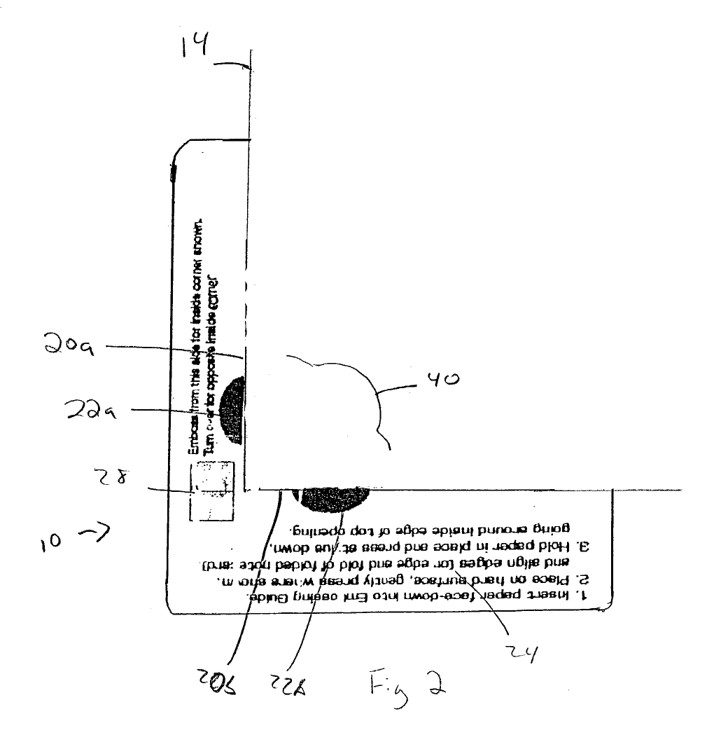

Next, at step 102, sheet media 14 is punched using a punch tool so as to form a slit 40. As illustrated in FIG. 2, slit 40 corresponds to the portion of the shape of embossing cutout 16 that is opposite of the corner of where alignment guidelines 20a and 20b converge.

At step 104, as illustrated in FIG. 2, sheet media 14 is placed on top of embossing guide 10 such that the corner and edges of sheet media 14 is disposed along the edges and corner of first and second guidelines 20a and 20b. Further, the user then places their fingers from one hand on the first and second finger locations 22a and 22b so as to hold sheet media 14 in place against embossing guide 10.

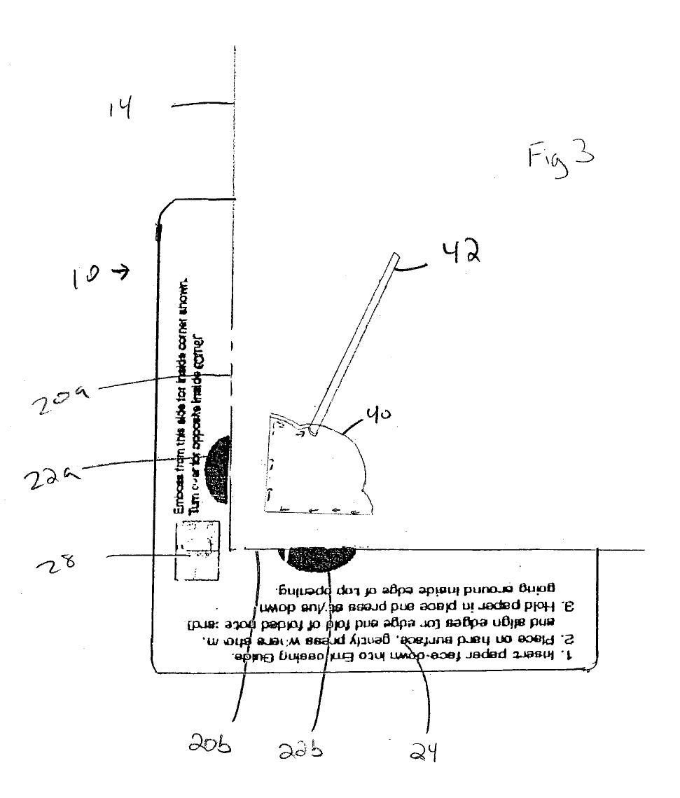

At step 106, as illustrated in FIG. 3, a stylus 42 is pressed against the surface of sheet media 14 disposed above embossing cutout 16 in the direction indicated by the arrows. Stylus 42 is moved around the edges, embossing the form of embossing cutout 16 into sheet media 14. After complete, sheet media 14 then maintains an embossed corner in the shape of embossing guide 16, and further maintains slit 40, located along the edge of the embossed portion that is going to be used to mount the desired item such as picture 15.

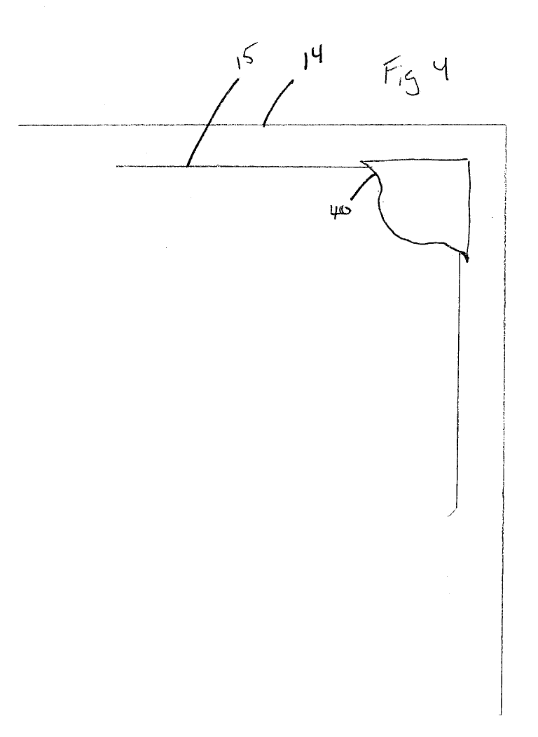

At step 108, using the appropriate upper and lower sides of embossing guide 10, the embossing and punching is completed around sheet media 14 so as to emboss and punch the remaining mounts necessary to mount picture 15. After complete, each corner of picture 15 is placed into the appropriate slit 40. A close up view of a single slit 40 with photo 15 mounted therein is illustrated in FIG. 4.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. An embossing guide for embossing a design into a sheet media, said embossing guide comprising:
first and second guidelines disposed on the top of said embossing guide, meeting at a defined angle; and
an embossing cutout, said embossing cutout disposed within said defined angle formed by said first and second guidelines such that when a corner and sides of said sheet media are aligned against said first and second guidelines, said sheet media will be accurately placed over said embossing cutout such that a stylus moved around the edges of said embossing cutout will emboss a desired design into said sheet media at a desired location.

2. An embossing guide as claimed in claim 1, wherein said embossing guide is constructed of a durable plastic.

3. An embossing guide as claimed in claim 1, wherein said sheet media is a anyone of craft paper or scrapbook paper.

4. An embossing guide as claimed in claim 1, wherein said first and second guidelines meet at a substantially right angle.

5. An embossing guide as claimed in claim 1, further comprising first and second finger portions, disposed along first and second guidelines respectively, configured to identify a location for a user to stably hold said sheet media against said embossing guide.

6. An embossing guide as claimed in claim 1, further comprising an instruction indicia disposed on said embossing guide configured to provide instructions to the user.

7. An embossing guide as claimed in claim 1, wherein said embossing guide is configured to be used in conjunction with a particular punch tool so as to punch a slit in said sheet media, corresponding to a portion of the embossed area formed by said embossing cutout so as to provide a means to mount a display item on said sheet media.

8. An embossing guide as claimed in claim 7, wherein said embossing guide further comprises a punch indicia containing information corresponding to said punch tool.

9. An embossing guide as claimed in claim 7, wherein said embossing cutout is in the shape of a photo mount.

10. An embossing guide as claimed in claim 7, wherein said display item for display on said sheet media is a photograph.

11. An embossing guide as claimed in claim 7, wherein said punch tool is configured to punch said slit into said sheet media such that said slit aligns with the edge of said embossing cutout, opposite the corner where said first and second guidelines intersect when said sheet media is properly aligned along said first and second guidelines.

12. An embossing guide as claimed in claim 9, wherein said punch tool is configured to punch said slit into said sheet media such that said slit aligns with the edge of said photo mount shaped embossing cutout, opposite the corner where said first and second guidelines intersect when said sheet media is properly aligned along said first and second guidelines.

13. An embossing guide as claimed in claim 11, wherein said display item is mounted into said slit in said sheet media.

14. An embossing guide as claimed in claim 12, wherein said photograph is mounted into said slit in said sheet media.

15. An embossing guide as claimed in claim 1, further comprising a second embossing cutout on said underside of said embossing guide, configured to provide a complementary embossing ability for opposing sides of single sheet media.

16. An embossing guide as claimed in claim 1, further comprising a first embossing guide alignment indicator disposed on the upper side of said embossing guide configured to instruct the user on the proper side of a folded said sheet media for use with said embossing cutout.

17. An embossing guide as claimed in claim 16, further comprising a second embossing guide alignment indicator disposed on the lower side of said embossing guide configured to instruct the user on the proper side of a folded said sheet media for use with said second embossing cutout.

18. A method for mounting a display item on a sheet media, said method comprising the steps of:
selecting a punch tool an punching a slit into said sheet media;
selecting a corresponding embossing guide for said punch tool and embossing a design into said sheet media wherein said slit is aligned along at least one edge of said embossed design; and
mounting said item for display by placing a corner of said display item into said slit.

19. The method for mounting a display item as claimed in claim 18, further comprising steps of repeating said punching and embossing step for each corner of said display item.
